(19) United States
(12) Patent Application Publication
(10) Pub. No.: US 2004/0111680 A1
(43) Pub. Date: Jun. 10, 2004

(54) Method for creating ROM soft IP for being built in micro controller soft IP and recording media having program for executing the same

(76) Inventors: Tae Young Lim, Daejon-Shi (KR); Myung Shin Kwak, Daejon-Shi (KR); Jong Dae Kim, Daejon-Shi (KR); Yang Ki Cho, Chungbuk Cheongju-Shi (KR); Seung Wan Song, Gyeonggi-Do (KR); Hi Seok Kim, Seoul (KR)

Correspondence Address: JACOBSON HOLMAN PLLC, 400 SEVENTH STREET N.W., SUITE 600, WASHINGTON, DC, 20004, US

(21) Appl. No.: 10/697,164

(22) Filed: Oct. 31, 2003

(30) Foreign Application Priority Data
Dec. 7, 2002 (KR) 2002-77596

(51) Int. Cl. G06F 17/50

(52) U.S. Cl. 716/1

(57) ABSTRACT

A method of creating a ROM soft IP that can be built in a micro controller soft IP and a recording medium having a program for executing the same method are provided. The ROM soft IP capable of being built in the MPU core IP, thereby an IP designer can easily design a ROM built-in MPU soft IP. In addition, a user of the MPU core IP can create the ROM soft IP that ROM program data having a size equal to that of the program can be inserted thereinto.

### BACKGROUND OF THE INVENTION

1. Field of the Invention

The present invention relates to a method of creating a ROM soft IP that may be built in a micro controller soft IP, more particularly, to a method of creating a ROM soft IP that may be easily combined with a micro controller core IP within the micro controller soft IP, which allows an IP designer to easily design a ROM built-in micro controller soft IP and also allows the micro controller core IP user to create the ROM soft IP that has the same size as that of the ROM program data.

2. Description of the Prior Art

Hereinafter, terms used in this specification will be defined.

The “micro controller” means a microprocessor unit (hereinafter referred to “MPU”), and the “IP” is short for “Intellectual Property,” which means a semiconductor design property. In addition, a “MPU core IP” means a MPU IP without a ROM and a “ROM soft IP” means a MPU IP having the ROM therein. Specifically, the “ROM soft IP” refers to a virtual component described by an electronic circuit design language, such as a Very High Speed Description Language (VHDL) or a Verilog, to define a certain MPU function that may be implemented as a chip, regardless of the design rules of a semiconductor process.

The “IP designer” means a person creating the semiconductor design property, and the “IP user” means a person creating a certain system by using the IPs. Also, the “program data” means Hex-formatted operational codes, which are programmed in the ROM to operate the MPU. A “hard IP” means an IP composed of connecting information among the electronic circuits, so that only a specific chip manufacturer can fabrication it.

Hereinafter, several prior art methods of designing the MPU IP and problems thereof will be explained.

Generally, in order to operate a certain MPU chip, a program for performing a corresponding MPU function, which is composed of a set of instructions in a Hex format, should be written at a read only memory (ROM) device (hereinafter, it may be referred to a “memory device”; In addition, it may be also referred to a “mask ROM,” a “program memory block,” or a “memory device block”), which may be located within or out of the MPU. Accordingly, the ROM built-in MPU chip must be designed to include a non-volatile programmable read only memory device such as an erasable programmable read only memory (EPROM) or an electrically erasable programmable read only memory (EEPROM), so that a user can write the program in the ROM after it has been completely manufactured.

In order to explain the methods of implementing the MPU IP according to prior arts (1st to 5^{th}) in detail, a MCU portion, a memory device portion, an IP type, a design system, and a design subjective arts are schematically described in Table 1.

TABLE 1

| | MPU implementation | | | | | |
|---|---|---|---|---|---|---|
| | | | Memory device portion | | Memory device built-in MPU IP | |
| | MCU portion | | Implementation | | implementation | |
| | Design | design | process | operating | | design system and |
| classification | method | subjective | technique | program | IP type | design subjective |
| first prior | Circuit | IP | EPROM or | The user | (circuit | 1. MCU → IP designer |
| art | diagram | designer | EEPROM | writes a | diagram- | 2. memory device → chip |
| | or | | | ROM | centered) | manufacturer |
| | design | | | program | hard IP | (semiconductor |
| | language | | | on the | | corporation) |
| second | | | | outside of | (design | 1. MCU → IP designer |
| prior art | | | | the | language- | 2. memory device → IP |
| | | | | commercialized | centered) | designer |
| | | | | chip | soft IP | |
| third prior | Circuit | IP | Mask ROM | The user | (circuit | 1. ROM |
| art | diagram | designer | | provides a | diagram- | program → ROM code → IP |
| | or | | | ROM | centered | user |
| | design | | | program | or design | 2. ROM code → ROM |
| | language | | | before the | language- | pattern → IP designer |
| | | | | chip is | centered) | 3. ROM pattern → CAD |
| | | | | completed | hard IP | tool → mask |
| | | | | | | ROM → IP |
| | | | | | | designer or chip |
| | | | | | | manufacturer |
| fourth | | | | | (design | similar to above |
| prior art | | | | | language- | |
| fifth prior | | | | | centered) | 1. ROM |
| art | | | | | soft IP | program → ROM code → IP |
| | | | | | | user |
| | | | | | | 2. ROM code → convert |
| | | | | | | to VHDL file and |
| | | | | | | modify a source file |
| | | | | | | for MPU core IP |
| | | | | | | already created → IP |
| | | | | | | designer |

However, the prior arts mentioned in Table 1 have the next problems, respectively.

First, in the first prior art method of designing EEPROM built-in MPU with the hard IP, the MPU core portion is designed by an IP designer, and the EEPROM portion is designed by a chip manufacturer. Accordingly, it has been a problem that the process condition depends on the chip-manufacturing corporation.

In the second prior art method of designing EEPROM built-in MPU with the soft IP, since it requires the complex chip manufacturing process and various variables, it is impossible to manufacture the EEPROM built-in MPU with the chip. Therefore, when designing the EEPROM built-in MPU with the soft IP, it has been a problem that only the MPU core portion must be designed without the ROM.

In the third prior art method of designing the mask ROM built-in MPU with the hard IP, wherein the mask ROM built-in MPU is manufactured by receiving the program data from the user of the MPU chip previously, changing them into a ROM pattern, and using the mask corresponding the pattern, the core portion is designed by a designer, while the mask ROM portion is designed by using a computer added design (CAD) tool, after the programming data and process information have been previously received from the IP user and the chip manufacturer, respectively. Thus, it causes many problems that it must be designed again depending to the process conditions and the designing methods at the time of changing the chip manufacturing corporation or the tool, and the programming data cannot be modified by the user of the MPU hard IP in the IP state.

In the fourth prior art method of designing the mask ROM built-in MPU with the soft IP, an electronic circuit of a ROM block is designed by receiving the program data from the IP user previously, converting them into the mask ROM code pattern by using a specific CAD tool by the IP designer, and carving them in a specific memory region by 4 kilobyte, further, electronic circuits of the MPU core portion are designed and coupled to each other by using another CAD tool, thereby the MPU soft IP is designed. Therefore, it causes some problems that the designed method must be changed when the CAD tool is changed, a surplus memory device is produced, and the user of the MPU soft IP cannot modify the program data (the data of the mask ROM) in the IP state.

In the fifth prior art method of designing the mask ROM built-in MPU with the soft IP according to the fifth prior art, the IP designer designs only the MPU core IP using the electronic circuit design language, and the IP user manually converts the hex operation code (the data of the mask ROM) programmed in the commercial MPU programming tool into a VHDL file for the memory, determines the size of the program memory in a source file for the MPU core IP created in advance, and modifies the source file portion associated with an address bus. Accordingly, it has troublesome in that the IP designer combines extracted blocks and performs a synthesis and a verification such as a simulation in order to verify a reliance of the modified IP by using the CAD tool, and also it causes some problems that the design time is increased and the method thereof becomes very complicated due to the manual operation. Furthermore, it has a problem that the user of the MPU soft IP cannot modify the program data in the IP state.

Accordingly, considering the above-mentioned prior arts as a whole, the EEPROM built-in hard IP has a problem that the process condition must be modified when the chip manufacturing corporation is varied, the mask ROM built-in hard IP has problems that the process condition or the design method must be changed when the chip manufacturing corporation or the CAD tool is varied and the program data can not be modified by the user of the MPU hard IP in the IP state.

In addition, the EEPROM built-in soft IP has a problem that only the core portion can be designed, since the chip manufacturing process is very complicated and there are many variables in the process technique. The mask ROM built-in soft IP has problems that the design method must be changed when the CAD tool is changed, and a surplus memory device is produced, the program data cannot be modified by the user MPU soft IP in the IP state. Further, the mask ROM built-in soft IP having the mask ROM described in the electronic circuit design language has problems that the design time is increased and the method thereof is very complicated due to many manual operations and the program data cannot be readily modified by the user of the MPU soft IP in the IP state.

### SUMMARY OF THE INVENTION

Thus, in order to solve the above-mentioned problems, the object of the present invention is to provide a method of creating a ROM soft IP which can be applied to simplify a circuit synthesizing procedure of the MPU soft IP by automatically converting a program ROM code for operating MPU (data of a mask ROM) into an electronic circuit design language file such as VHDL in a ROM component file type in order to allow the data of the mask ROM built in the MPU to be an IP type, and which can be applied to minimize the size of the chip than a specific size of the mask ROM.

The another object of the present invention is to provide a method of creating a ROM soft IP as an independent file type, wherein the MPU program data (the mask ROM data) can be easily converted by the user of the MPU soft IP and the coding can be performed up to the exterior ROM capacity at a maximum by accommodating the most significant address.

In addition, the another object of the present invention is to provide a method of creating a ROM soft IP, wherein the ROM built-in MPU soft IP can be easily designed by the user of the MPU soft IP so as to accommodate the maximum ROM capacity and the user of the MPU soft IP can independently change, modify, or delete the MPU program data so as to use only the MPU core IP.

In addition, the another object of the present invention is to provide a method of creating a ROM soft IP, which can be described by the electronic circuit design language and implemented as a chip by any semiconductor chip manufacturing corporation, regardless of whether the semiconductor chip manufacturing corporation has the ROM manufacturing process technique or not.

According to an aspect to the present invention, a method of creating a ROM soft IP comprising the steps of (a) preparing a head file which describes the initial information of the ROM soft IP in a given electronic circuit design language a tail file which describes the end information of the ROM soft IP in the given electronic circuit language, and an empty ROM soft IP file, and selecting a hex file for a MPU program memory, which includes a start address (s) and an instruction (s) composed of ASCII characters; and (b) copying the head file into the first part of the empty ROM soft IP file; converting the hex file for the MPU program memory into the given electronic circuit design language expression and writing the converted expression into the middle part of the ROM soft IP file, and copying the tail file into the last part of the ROM soft IP file.

On the other hand, the procedure of converting the hex file for the MPU program memory into the given electronic circuit design language expression in the step (b) is performed by analyzing the start address (s) and the instruction (s) in the hex file and transforming them into binary codes, respectively, and the ROM soft IP may be described in any one of the electronic circuit design languages including Very High Speed Description Language (VHDL) and Verilog. In addition, the ROM soft IP can be built in the MPU instead of a mask ROM.

Also, the head file has the initial information may include a library to be applied to the IP, the name of the IP, and an input/output signals, and the sentence for describing the ROM address and the instruction of the address, the initial information and the sentence may be described in the electronic circuit design language, and the tail file may have last data of the ROM and a end sentence described in the electronic circuit design language.

In addition, it is preferable that the procedure of converting the instruction into an electronic circuit design language in the step (b) is performed by describing the number of the instructions of the hex file composed of ASCII character in a decimal by using a function converting a character into an integer.

The ROM soft IP described in the electronic circuit design language may be incorporated with a MPU core IP and may be built-in as an accessory.

The step of incorporating the ROM soft IP with the MPU core IP and performing circuit synthesizing and verifying procedures by a CAD tool may be included.

According to another aspect of the present invention, a computer readable recording media having a program for executing the above-mentioned method of creating the ROM soft IP.

### BRIEF DESCRIPTION OF THE DRAWINGS

FIG. 1 is a flowchart of a method of creating a ROM soft IP and further combining the ROM soft IP with a MPU core IP, in order to generate a ROM built-in MPU soft IP according to a preferred embodiment of the present invention.

FIG. 2 is a conceptual block diagram illustrating the schematic structure of the MPU soft IP and the connecting relationship between the IPs.

FIG. 3 illustrates an example of a head file (head.vhd) used in the method of creating the ROM soft IP in FIG. 1.

FIG. 4 illustrates an example of a tail file (tail.vhd) used in the method of creating the ROM soft IP in FIG. 1.

FIG. 5 illustrates an example of a hex file (watch.vhd) used in the method of creating the ROM soft IP in FIG. 1.

FIGS. 6A and 6B are flowcharts of the detailed implemented steps of a method of creating the ROM soft IP in FIG. 1.

FIG. 7 is an example of the ROM soft IP file created by performing the method of creating the ROM soft IP shown in FIG. 1.

### DESCRIPTION OF THE PREPERRED EMBODIMENTS

Hereinafter, the preferred embodiments of the present invention will be explained with reference to the accompanying drawings, such that those skilled in the art can easily embody the technical aspect of the present invention.

The present invention suggests an algorithm capable of creating a new ROM soft IP by converting the ROM data into an electronic circuit design language file (referred to a “ROM soft IP creating algorithm”). The “ROM soft IP creating algorithm” is the algorithm for creating an independent ROM soft IP that may be incorporated with or inserted into the MPU soft IP, by converting the mask ROM data, which has a specific use and a specific size and which may be built-in the MPU soft IP or attached to the outside thereof, into the electronic circuit design language file by calling and executing a ROM code converting program. The ROM code-converting program may be generated using programming software such as Visual C.

Specially, the algorithm is for creating the ROM soft IP, by reading a hex file in which the mask ROM codes programmed to perform a particular purpose of the MPU have been stored and then converting it into the electronic circuit design language (such as VHDL) file, to create a ROM component file having the same size with that of the mask ROM codes. According to the above algorithm, the size of the chip can be minimized and the ROM soft IP having a various size (such as the size capable of incorporating up to the outside portion of the ROM) can be created by accommodating the most significant address of the MPU. In addition, the ROM can be built by the user as well as the designer of the MPU core IP and the electronic circuit design language file can be implemented as a chip by any semiconductor manufacturing corporation, regardless of whether the semiconductor manufacturing corporation has a ROM manufacturing process technique or not. The above algorithm can be also easily used in a design of various types of System On a Chip (SoC), which requires for the mask ROM type of the memory block.

Hereinafter, a method of creating a ROM soft IP and further incorporating the ROM soft IP with the MPU core IP, to generate the ROM built-in MPU soft IP, according to the preferred embodiment of the present invention will be explained with reference to the accompanying drawings.

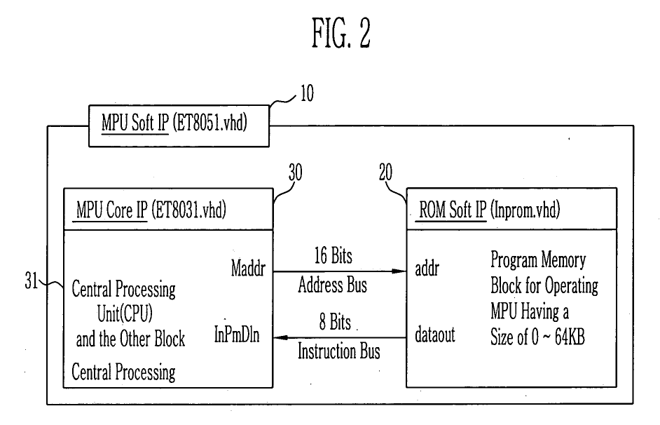

First, referring to FIG. 2, the schematic structure of the MPU soft IP and the relationship between IPs will be explained. FIG. 2 shows a conceptual block diagram illustrating the schematic structure of the MPU soft IP and the connecting relationship between the IPs. But, the system and the file names applied to a ROM built-in MPU soft IP 10 are used as examples for convenience of the explanation of the present invention.

Referring to FIG. 2, a ROM soft IP 20 capable of coding a program for operating the MPU having a size of 1-64 KB is created. When a 16-bit address bus (addr) is input to a ROM soft IP 20 (referred to “Inprom.vhd”), the ROM soft IP 20 outputs an 8-bit instruction bus (dataout). The ROM soft IP 20 is incorporated with a MPU core IP 30 referred to ET8031.vhd to pass through circuit synthesizing and verifying procedures by the CAD tool, so as to be applied to the ROM built-in MPU soft IP 10 referred to ET805 1.vhd.

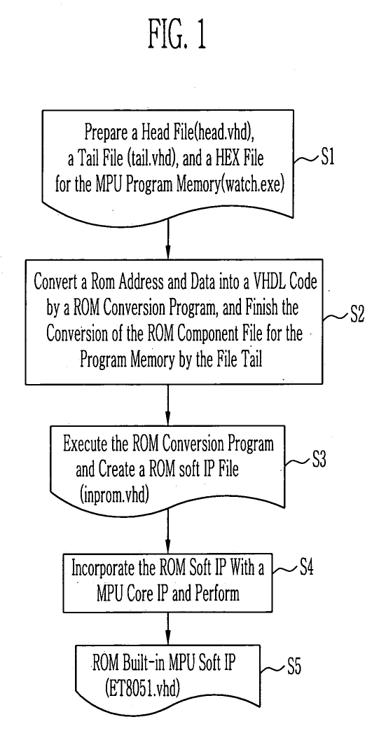

Next, the flowchart in FIG. 1 will be explained in detail.

(S1 Step)

A head file describing initial information of the ROM soft IP and a tail file describing the end information thereof described in the electronic circuit design language is prepared in a workstation or a personal computer (PC) environment. Also, an empty ROM soft IP is prepared and a hex file for the program memory of the MPU that is composed of ASCII characters and is to be converted into the ROM soft IP is prepared (S1).

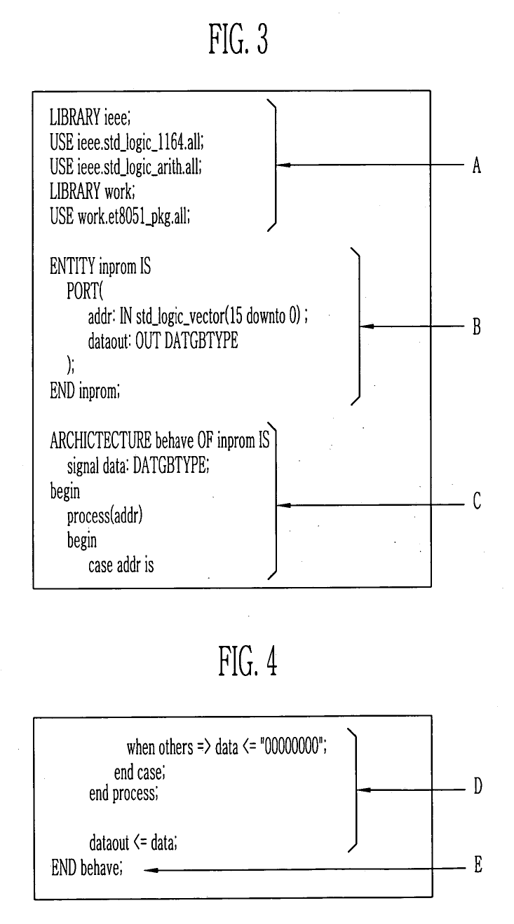

The ROM soft IP 20 will be explained in detail. FIG. 3 illustrates the structure of head file (“head.vhd”). In the head file, the initial information of the ROM soft IP 20, such as a library to be applied to the IP (A) and the name of the IP, input/output signal (B) and a statement defining the structure of a ROM address and an instruction, may be specified using the electronic circuit design language. Please note that the head file (“head.vhd”) is the head file portion extracted from the VHDL file creating type according to the International Standard.

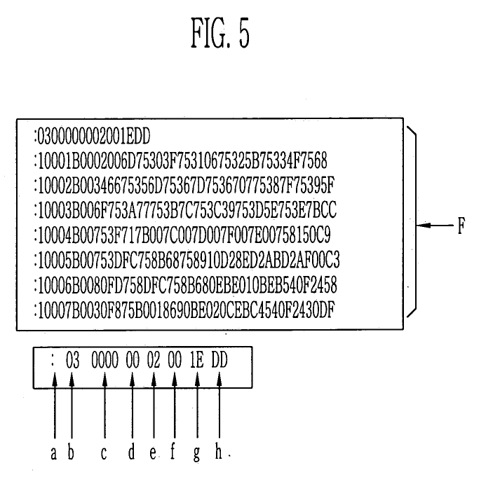

In addition, the tail file, which is referred to “tail.vhd” is shown in FIG. 4. In FIG. 4, in the tail file, the data of the ROM (D), and the end statement (E) may be specified using the electronic circuit design language. Please note that the tail file (“tail.vhd”) is the tail file portion extracted from the VHDL file creating type according to the International standard.

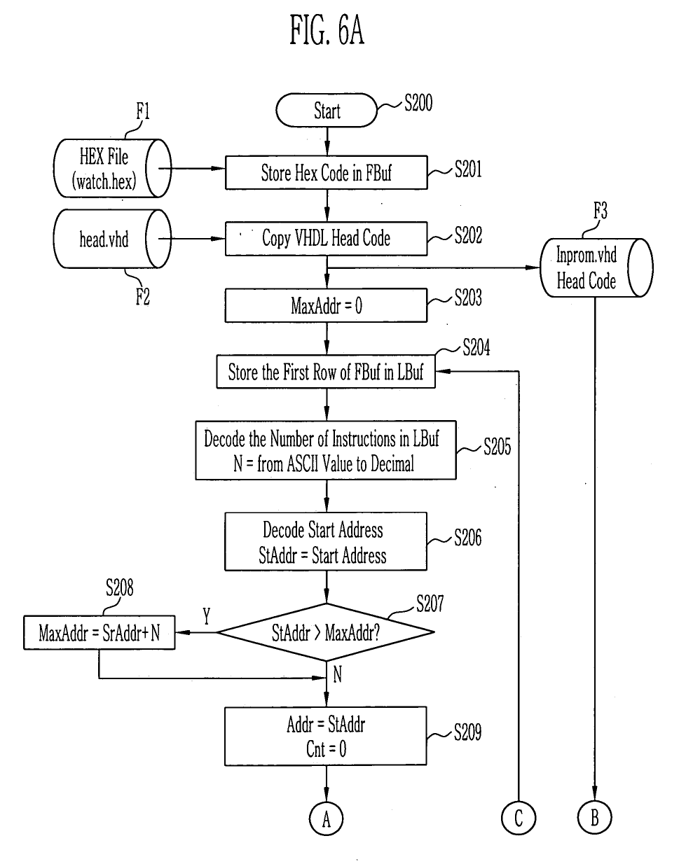

In addition, the hex file for the program memory of the MPU composed of ASCII characters is prepared. In this example, the file for operating the watch function referred to “watch.hex” is prepared and is shown in FIG. 5. The hex file (watch.hex) in FIG. 5 allows the user of the MPU to perform the programming and has a specific rule and a specific meaning therein. Hereinafter, this will be explained in detail. The first character (:,a) of the first row in the hex file (watch.hex) means the start of the row. Also, the second and third characters (03, b) represent the number of the OP code included in this row with a hexadecimal, and, in this case, mean that there are three OP codes. The fourth to seventh characters (0000, c) represent the start address of the row, and, in this case, represent the address 0000 with the hexadecimal. The eighth and ninth characters (00, d) represent the last line and is shown with 01 only when the line is the last line. The tenth and eleventh characters (02, e), the twelfth and thirteenth characters (1E, f), the fourteenth and fifteenth characters (DD, h) mean three OP codes included in this row. In addition, the fourteenth and fifteenth characters are shown at the last portion in the row as a check sum. The coding and the length of the hex file are varied according to how the MPU is used by the user.

(S2 Step)

Next, the ROM code conversion program (referred to “Romconv.exe”) will be executed to perform inserting the head file (“head.vhd”); into the empty ROM soft IP file; reading, the hex file for the program memory (“watch.hex”) and converting the ROM addresses and the data in the hex file into the VHDL codes, using functions of the programming software, so as to be written to the ROM soft IP file having the head file inserted (S2).

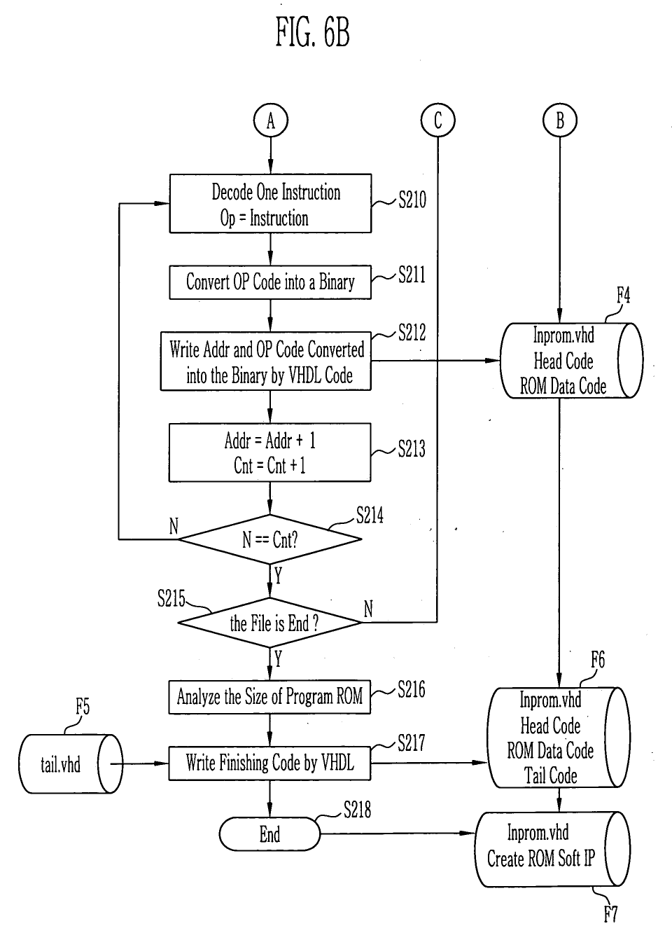

Such a ROM code conversion program can be implemented by suitably mixing with a script file or a batch file using the programming software by a person having general design knowledge. Hereinafter, the method of creating the ROM soft IP according to the preferred embodiment of the present invention will be explained in detail, with reference to FIGS. 6A and 6B.

In order to create the ROM code conversion program, first, all the contents of the hex file for the ROM code (F1: “watch.hex”) which is composed of ASCII characters and is extracted by compiling a source file for the program memory of the MPU is read and is stored in a certain variable (FBuf) (S201). Thereafter, the previously created head file (F2: “head.vhd”) is copied and is written to an upper portion of the empty file for the new ROM soft IP (F3: “Inprom.vhd”) (S202), the variable “MaxAddr” that checks whether the address is increased as many as the size of the program memory is set to “0“(S203). Next, after the first row of the hex file for the program memory stored in FBuf is read, it is stored in the variable referred to LBuf (S204). Thereafter, the second and third characters (b) of the LBuf are read and stored in the variable tempStr, and the variables N having a number as many as the instruction are created by the function asc2Num for converting the variable tempStr and one character into an integer in next equation 1.

N=asc2Num(tempStr(0)(second character is 0, and the value of the ASCII code is 48))*16+asc2Num(tempStr(1)(third character is 3, the value of the ASCII code is 51)) (1)

Accordingly, by the equation 1, “03” that are the second and third characters, respectively (b) is converted into “3” that is the ASCII value, thereby the number of the variable N is prepared (S205). The start address is analyzed and is stored in the variable StAddr (S206), and then whether the start address “StAddr” is more than the program memory increasing variable “MaxAddr” is determined (S207). If so, “StAddr” and “N” are added to each other to increase “MaxAddr” (S208), and, if so not, “StAddr” is regarded as the address (Addr) and the increasing variable “Cnt” is set to “0” (S209).

Next, one instruction is analyzed to create the OP code (S210), and the OP code is converted into a binary (S211), and the address (Addr) and the OP code converted into the binary are written in the VHDL as the head code of the ROM soft IP (“Inprom.vhd”) and the ROM data code (F4) (S212). Thereafter, the address and the increasing variable “Cnt” are increased by “1”, respectively (S213), and whether the number of the instruction N is equal to the instruction increasing variable “Cnt” is determined (S214). If the number of the instruction N is not the last instruction-increasing variable, the process returns to the step S210 such that the next instruction is analyzed. If N is the last instruction variable, whether the file is the end is determined (S215). If so not, the process returns to the step S204 such that the next row is read, and, if so, the size of the program memory is analyzed (S216). Thereafter, a finishing code is written to inprom.vhd (F6) having the head file, the ROM data file, and the tail file written in the VDHF by using the tail file (tail.vhd) (F5) (S217), and the process is finished (S218).

On the other hand, it is not necessary that the above-mentioned hex file for the ROM code (watch.hex) be extracted by compiling the source file for the program memory of the MPU. The instruction can be converted into the hex file for the ROM code expressed with only the data, and, in this case, a method of automatically increasing the start address is performed in the concrete embodiment.

(S3 Step)

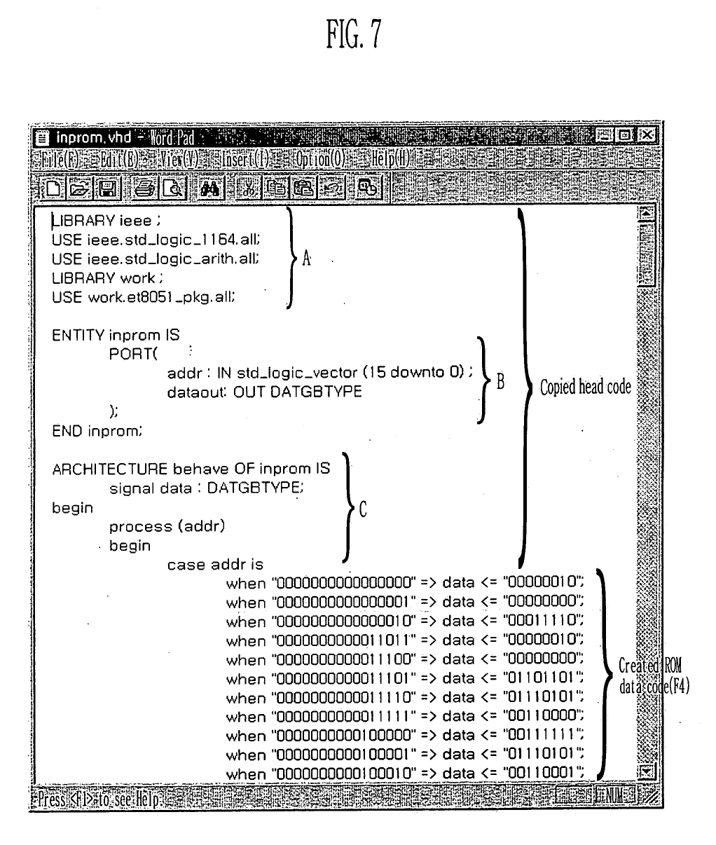

Returning to FIG. 2, the process subsequent to the step S2 will be explained. The ROM soft IP 20 executes the ROM code conversion program referred to “RomConv.exe” in the workstation or PC environment, thereby a ROM soft IP file referred to” Inprom.vhd” (F7 in FIG. 6B) is created, as shown in FIGS. 6A and 6B. On the other hand, once the ROM code conversion program is created in the above-mentioned, method, the program can be executed, replacing only the hex file for the ROM code (watch.hex), so that a file for a new ROM soft IP (Inprom.vhd) capable of being applied to the same kind of the MPU can be created. In addition, if the head file, the tail file, and the hex file for the ROM code are changed, a file for a new ROM soft IP capable of being applied to the different kind of the MPU can be created. An example of the ROM soft IP created in the above-mentioned method is shown in FIG. 7. The created ROM soft IP file includes the copied head code (A, B, and C) portion, the created ROM data code (F4) portion, and the tail cod (D and E) portion. But, in FIG. 7, only the portion having the copied head code (A, B, and C) portion and the created ROM data code (F4) portion among the codes are shown.

(After S4 Step)

Since the ROM soft IP (“Inprom.vhd”) created in the above-mentioned method is the file described in the electronic circuit design language, it can be incorporated with the MPU core IP 30 shown in FIG. 1 to be built-in like as an accessory, and, accordingly, can be easily used to the ROM built-in MPU soft IP by passing through the circuit synthesizing and verifying procedures by the CAD tool.

Although the present invention has been illustrated and described with respect to exemplary embodiments thereof, the present invention should not be understood as limited to the specific embodiment, and it should be understood by those skilled in the art that the foregoing and various other changes, omission and additions may be made therein and thereto, without departing from the spirit and scope of the present invention.

The present invention is mainly explained with respect to the method of creating the ROM soft IP, but, by those skilled in the art, the mechanism of the present invention including various kinds of the instructions can be programmed and a computer-recording medium having such program can be distributed. As the example of the computer readable recording medium, a hard disk, a floppy disk, a hard disk drive, and a CD-ROM may be included.

As mentioned above, according to the present invention, the ROM soft IP that can be built-in the MPU, instead of the mask ROM, can be created, and can be widely used in designing various system chips (SoC; System On a Chip) having the ROM therein.

What is claimed is:

1. A method of creating a ROM soft IP comprising the steps of:
(a) preparing a head file which describes the initial information of the ROM soft IP in a given electronic circuit design language, a tail file which describes the end information of the ROM soft IP in the given electronic circuit language, and an empty ROM soft IP file, and selecting a hex file for an MPU program memory, which includes a start address (s) and an instruction (s) composed of ASCII characters; and
(b) copying the head file into the first part of the empty ROM soft IP file, converting the hex file for the MPU program memory into the given electronic circuit design language expression and writing the converted expression into the middle part of the ROM soft IP file, and copying the tail file into the last part of the ROM soft IP file.

2. The method of creating the ROM soft IP according to claim 1, wherein the procedure of converting the hex file for the MPU program memory into the given electronic circuit design language expression in the step (b) is performed by analyzing the start address (s) and the instruction (s) in the hex file and transforming them into binary codes, respectively.

3. The method of creating the ROM soft IP according to claim 1, wherein the ROM soft IP is described in any one of the electronic circuit design languages including very high speed description language (VHDL) and Verilog.

4. The method of creating the ROM soft IP according to claim 1, wherein the ROM soft IP can be built in the MPU instead of a mask ROM.

5. The method of creating the ROM soft IP according to claim 1, wherein the head file has the initial information including a library to be applied to the IP, the name of the IP, and an input/output signal, and the statement for describing the ROM address and the instruction at the address, the initial information and the statement being described in the electronic circuit design language, and
the tail file has last data of the ROM and an end statement described in the electronic circuit design language.

6. The method of creating the ROM soft IP according to claim 1, wherein the procedure of converting the instruction into the electronic circuit design language in the step (b) is performed by describing the number of the instructions of the hex file composed of ASCII characters in a decimal by using a function converting a character into an integer.

7. The method of creating the ROM soft IP according to claim 1, wherein the ROM soft IP described in the electronic circuit design language is incorporated with an MPU core IP and is built-in as an accessory.

8. The method of creating the ROM soft IP according to claim 7, further comprising the step of incorporating the ROM soft IP with the MPU core IP and performing circuit synthesizing and verifying procedures by a CAD tool.

9. A computer readable recording media having a program for executing a method of creating a ROM soft IP the steps of:
(a) preparing a head file which describes the initial information of the ROM soft IP in a given electronic circuit design language, a tail file which describes the end information of the ROM soft IP in the given electronic circuit language, and an empty ROM soft IP file, and selecting a hex file for an MPU program memory, which includes a start address (s) and an instruction (s) composed of ASCII characters; and
(b) copying the head file into the first part of the empty ROM soft IP file, converting the hex file for the MPU program memory into the given electronic circuit design language expression and writing the converted expression into the middle part of the ROM soft IP file, and copying the tail file into the last part of the ROM soft IP file.

10. The computer readable recording media according to claim 9, wherein the procedure of converting the hex file for the MPU program memory into the given electronic circuit design language expression in the step (b) is performed by analyzing the start address (s) and the instruction (s) in the hex file and transforming them into binary codes, respectively.

11. The computer readable recording media according to claim 9, wherein the ROM soft IP is described in any one of the electronic circuit design languages including very high speed description language (VHDL) and Verilog.

12. The computer readable recording media according to claim 9, wherein the ROM soft IP can be built in the MPU instead of a mask ROM.

13. The computer readable recording media according to claim 9, wherein the head file has the initial information including a library to be applied to the IP, the name of the IP, and an input/output signal, and the statement for describing the ROM address and the instruction at the address, the initial information and the statement being described in the electronic circuit design language, and
the tail file has last data of the ROM and an end statement described in the electronic circuit design language.

14. The computer readable recording media according to claim 9, wherein the procedure of converting the instruction into the electronic circuit design language in the step (b) is performed by describing the number of the instructions of the hex file composed of ASCII characters in a decimal by using a function converting a character into an integer.

15. The computer readable recording media according to claim 9, wherein the ROM soft IP described in the electronic circuit design language is incorporated with an MPU core IP and is built-in as an accessory.

16. The computer readable recording media according to claim 9, further comprising the step of incorporating the ROM soft IP with the MPU core IP and performing circuit synthesizing and verifying procedures by a 6CAD tool.
